(19) United States
(12) Patent Application Publication
(10) Pub. No.: US 2002/0097896 A1
(43) Pub. Date: Jul. 25, 2002

(54) DEVICE AND METHOD FOR SCANNING AND MAPPING A SURFACE

(76) Inventor: LARS KUCKENDAHL, BAB OLDESLOE (DE)

Correspondence Address: STUART E BECK, SUITE 601, ONE PENN CENTER SUITE 601, 1617 J F K BOULEVARD, PHILADELPHIA, PA, 191031806

(21) Appl. No.: 09/080,900

(22) Filed: May 18, 1998

Related U.S. Application Data
(60) Provisional application No. 60/078,325, filed on Mar. 17, 1998.

(51) Int. Cl. G06K 9/00

(52) U.S. Cl. 382/124

(57) ABSTRACT

A device for scanning the surface of an item comprising a scanning zone and means for projecting a pattern of light dots onto the surface to be scanned when it is in the scanning zone. Means are provided for detecting the pattern of light dots. Means are also provided for making a grey scale image of the surface, and means are provided for combining the light dot pattern with the grey scale image to create a two dimensional reproduction of the item that was scanned.

A method of scanning and capturing the image of a surface which surface has a plurality of features and each feature being in a particular place on the surface. The method comprises placing an object which surface is to be scanned in a scanning zone and placing a plurality of reference points on the surface so that some of the reference points correspond to some of the features. The location of the features on the surface is determined by locating the reference points that correspond to the features so that the image is captured.

### FIELD OF THE INVENTION

This invention relates a device and method for scanning and mapping a surface and more particularly, to a device which enables a touchless method for mapping a surface.

### BACKGROUND OF THE INVENTION

Over the years, many devices and methods have been developed for creating two-dimensional images based on three-dimensional objects. The most prevalent use of this type of device is in the scanning and/or storage and reproduction of fingerprints.

However, devices and methods that have been used have suffered from a disadvantage in that the surface being mapped must be brought into engagement with a platen or other surface which is usually transparent through which an image of the surface is captured.

Because the surface being captured contacts another element during the capturing process, the surface becomes distorted and a true image of the surface can not be obtained.

A typical instance of this problem arises in the case of taking a fingerprint from a subject. In manual systems finger-print capture includes inking the fingers of the subject, and then having the subject roll the inked fingers, one at a time, over prescribed locations on a specially designed card to transfer images of their fingerprints to the card. If the subject is a suspected criminal, a very young person, a person with arthritis or other disability they may be unwilling or unable to roll their fingers in a manner that is suitable for satisfactorily transferring the fingerprint to the card.

Further, cold or dry fingers often yield poor fingerprints. Many times the card is unusable and the fingerprint must be taken a second or third time. Further, since some parts of the fingerprint such as the ridges are higher than others, a failure to apply sufficient pressure will not capture the lower portions of the fingerprint, i.e., the valleys between the ridges. On the other hand the application of too much pressure may result in an unreadable smudge of ink.

To some extent the problems attendant the capturing of fingerprints with ink have been reduced by using optical, thermal or conductive-resistance devices. Typically in the optical devices the finger is placed on a transparent platen and the fingerprint is photographed or captured electronically by a mechanism on the other side of the platen. However, even with these devices the residue left by a prior user or by a prior finger might be read simultaneously with the fingerprint of the subject thereby creating an image having the appearance of a double exposure or in those instances where insufficient pressure has been applied the residue may fill the empty space without the operator realizing it. The result is a defective fingerprint of which no-one is aware until long after it is taken. Further the finger is flatted when it is placed on the platen which causes it to be distorted. Still further, an uncooperative subject may apply uneven pressure across the fingertip while the fingerprint is being captured thereby distorting the fingerprint without the person supervising the process realizing it.

In addition, each time the platen is cleaned minute scratches are made so that over a period of time the scratches interfere with the capturing of the fingerprint.

Thermal and conductive-resistive devices solve some of these problems. However, they are still contact devices. Hence, the problem of distortion remains. Further, uncooperative or incapable subjects can defeat these devices just as they defeat ink based systems.

These difficulties cause substantial expense, inconvenience and delay in the collection and processing of fingerprints. Further, because of the skills involved in taking fingerprints, only a small group of highly trained professionals is capable of performing this task.

Further, none of these systems are capable of creating an image of a surface which is comparable to that achieved by actually rolling the surface over a substrate on which the image of the surface is to be captured. Accordingly the amount of surface area captured has often not been sufficient to accurately classify and/or compare images with sufficient detail to be sorted, classified or compared. This is especially important in the case of fingerprint identification.

It would be desirable if the task of capturing, storing fingerprints were simplified and automated that persons of relatively modest skills could perform these tasks with relative ease after a minimum amount of training.

Further, it would also be desirable if the image captured could cover a substantial portion of the surface to be examined comparable to that which would be achieved if the surface were rolled over the substrate on which it was captured but without the distortion attendant an actual rolled capture such as when a fingerprint is taken.

### SUMMARY OF THE INVENTION

Thus, with the foregoing in mind, the invention relates to a device for scanning the surface of an item comprising a scanning zone and means for projecting a pattern of light dots onto the surface to be scanned when it is in the scanning zone. Means are provided for detecting the pattern of light dots. Means are also provided for making a grey scale image of the surface, and means are provided for combining the light dot pattern with the grey scale image to create a two dimensional reproduction of the item that was scanned.

In another aspect the invention relates to a method of scanning and capturing the image of a surface which surface has a plurality of features and each feature being in a particular place on the surface. The method comprises placing an object which surface is to be scanned in a scanning zone and placing a plurality of reference points on the surface so that some of the reference points correspond to some of the features. The location of the features on the surface is determined by locating the reference points that correspond to the features so that the image is captured.

### DESCRIPTION OF THE DRAWINGS

FIG. 1 is a perspective view of a device constructed in accordance with a presently preferred form of the invention.

FIG. 2 is a side view, partially in section of the interior of the device illustrated in FIG. 1.

FIG. 3 is a block diagram that generally describes the method of the invention.

FIG. 4 is a plan view of a part of the surface of a finger or other generally cylindrical object with a pattern of light dots projected on it in accordance with the invention.

FIG. 5 is a grey scale (photographic) image of that part of the surface of a finger or other generally cylindrical object which is illustrated in FIG. 4 and showing the features of its surface.

FIG. 6 is a plan view of that part of the surface of a finger or other generally cylindrical object which is illustrated in FIGS. 5 and 6 with the pattern of dots superimposed on the features of the surface.

FIG. 7 is a partial section view taken along line 7-7 of FIG. 2.

FIG. 8 is a partial section view taken along line 8-8 of FIG. 2.

FIG. 9 is a plan view of one of the detection plates detecting the first pattern of light clusters.

FIG. 10 a plan view of same part of the surface of a finger or other generally cylindrical object as shown in FIG. 4, but with a second pattern of light dots projected on it.

FIG. 11 is a plan view of the detection plate shown in FIG. 9, but detecting a second pattern of light clusters.

FIG. 12 is a block diagram that generally shows the steps in the enhancement of the light clusters.

FIGS. 13, 14 and 15 show the steps in determining which light clusters are the reflections of light dots.

FIG. 15 is a plan view of the detection plate shown in FIG. 11 after the light clusters are further processed.

FIG. 16 shows a further step in determining which light clusters are the reflections of light dots.

FIGS. 17, 18 and 19 show three methods for finding the centers of the light clusters.

FIG. 20 is a plan view of detection plate showing the centers of the light clusters.

FIG. 21 is a schematic showing the method for locating the three dimensional position of the light dots.

FIG. 22 is a schematic showing the method for mapping a three dimensional coordinates into a two dimensional plane.

FIG. 23 is a pictorial view of a plurality of devices constructed in accordance with invention arranged to scan the surface of an elongated item.

FIG. 24 shows a step in creating a composite grey scale image.

FIG. 25 shows a completed composite grey scale image.

FIGS. 26, 27 and 28 show other systems for creating the light dots.

FIG. 29 shows another system for finding the three dimensional coordinates of an item being scanned.

FIGS. 30 and 31 show a composite scanned image based on three detection systems.

FIGS. 32 and 33 show a composite scanned image based on four detection systems.

### Description of a Preferred Embodiment of the Invention

The Device

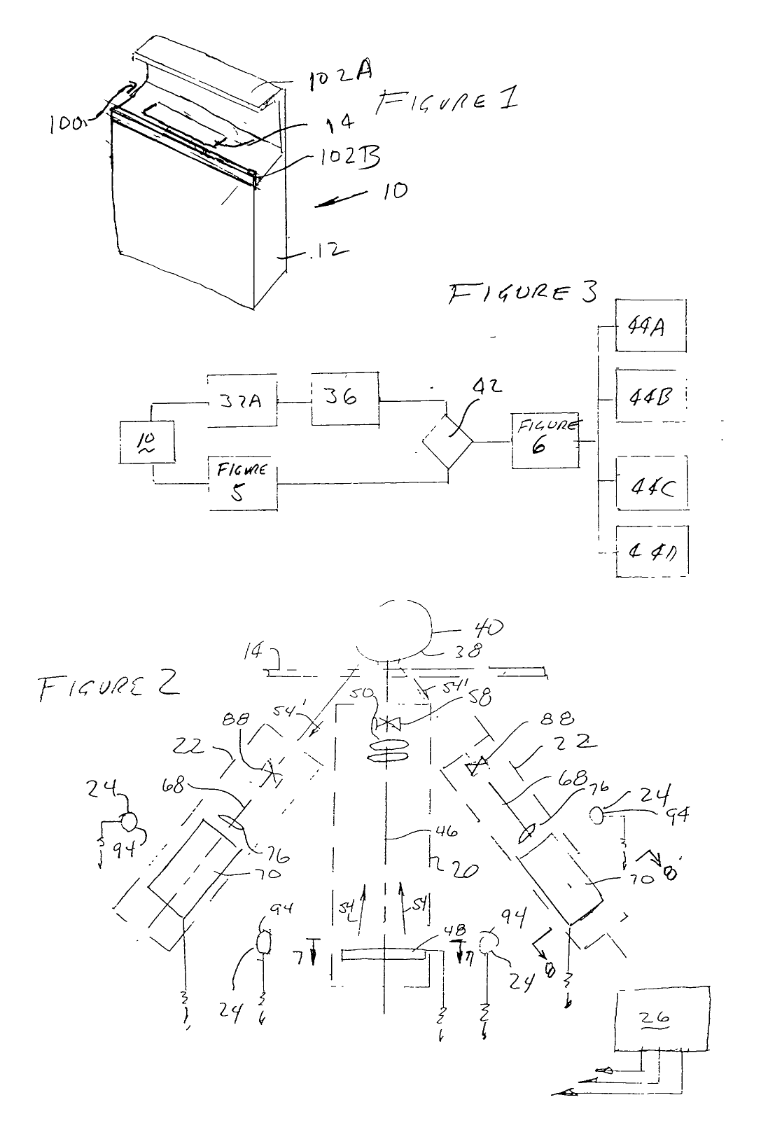

Referring to FIG. 1, a scanning device 10 of a type contemplated by the invention is illustrated. The device can scan the image of a curved or otherwise irregular surface as though the surface were in rolling contact with the medium on which it will be captured. The device 10 comprises a housing 12 and a transparent end wall 14.

As seen in FIG. 2 the housing 12 contains a projection system 20, a detection system 22, a lighting system 24, a timing circuit 26 and a programmable computer.

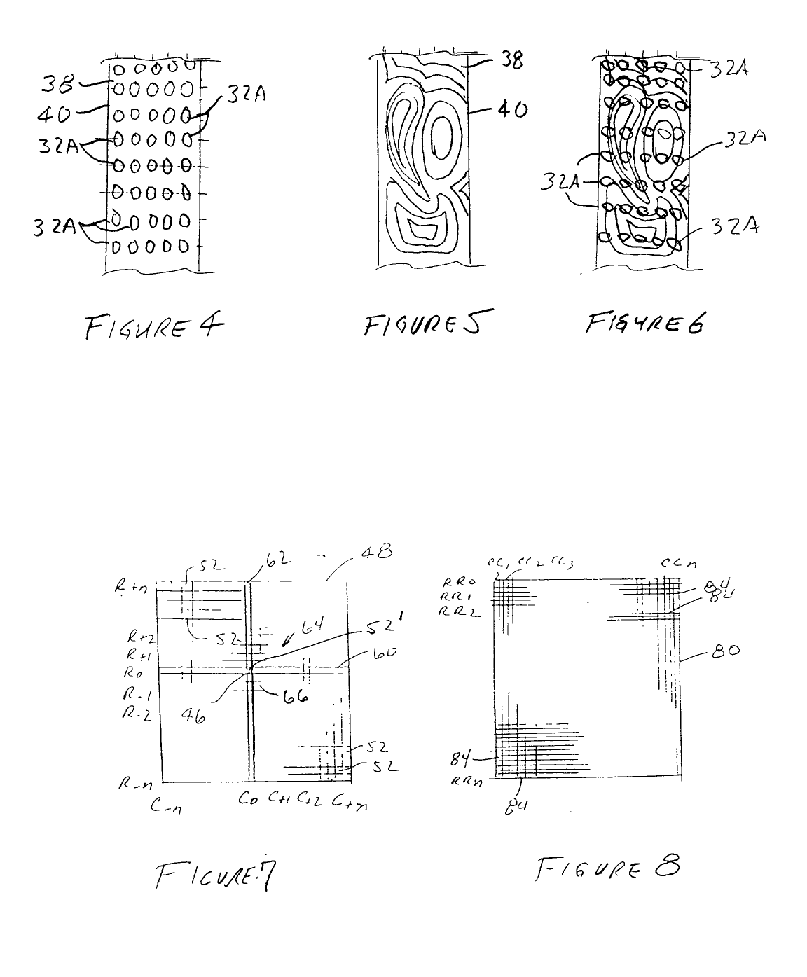

As seen in FIG. 2, the projection system 20 projects a pattern of light dots 32A onto the surface 38 an item 40 to be scanned. Then as seen in FIG. 4, the surface to be scanned 38 is lit by the lighting system 24 to illuminate its features.

As best seen in FIG. 3, the item to be scanned is placed over the device 10. In rapid succession and controlled by the timing circuit 26, the detection system 22 detects both the pattern of light dots 32A reflected from the surface to be scanned 38 (FIG. 4) and a grey scale (photographic) image (FIG. 5) of the surface 38 as illuminated by the lighting system 24. The coordinates of the three dimensional position of each of the light dots 32A is then determined at 36. Consequently, the coordinates of all of the light dots 32A comprise a statement of the shape of the surface, including relative heights, widths and lengths among the various light dots 32A.

In the preferred embodiment of the invention each particular light dot 32A is associated with a particular part of the grey scale (photographic) image of the surface 38 being scanned. Since the three dimensional location of each of the light dots 32A is known, the particular part of the grey scale image associated with that particular light dot 32A is also known.

Therefore, by placing the parts of the grey scale (photo-graphic) image where their corresponding light dots 32A are determined to be located 42 and then adding the remainder of the grey scale image, a three dimensional grey scale copy of the surface can be made (FIG. 6).

From this information, using well known mapping techniques, a two dimensional drawing of the surface 38 may be made such as on an FBI fingerprint card 44A, or an image of the surface can be projected onto a viewing screen or monitor 44B for real time or later viewing.

Further, the information can be stored 44C in either its three dimensional form or its two dimensional form for later use such as for comparison to permit access to secure areas, detect unauthorized reproductions or forgeries of items, study sculptures, record and compare facial images or other body parts and the like.

Further, it can be used 44D to record, compare or analyze surface variations and abnormalities on anatomical parts or manufactured or naturally occurring items, or in any other area where it useful to be able to map the surface of an item whose surface lies in three dimensions where it is difficult or impossible to bring the surface into engagement with a recording or mapping medium.

The Projection System

As best seen in FIG. 2 the projection system 20 comprises a projection axis 46, a projection plate 48 and a lens system 50. The projection axis 46 extends through the transparent end wall 14, the projection plate 48 and the lens system 50. The lens system 50 has a focal point 58 which lies along axis 46.

As seen in FIG. 7, the projection plate 48 comprises a large number, e.g., several hundred, miniature projectors 52. The projectors may be selected so that they project conventional white light onto the surface 38 of the item being scanned. However, it is preferred that infrared or near infrared light be used since better imaging will be achieved. This is because conventional white light might be filtered out by some glass filters and it makes the device 10 usable even when exposed to daylight. Further, since visible white light can then be filtered out, a high contrast picture will result.

The projectors are preferably arranged in a formation such as the rectangular grid shown. Preferably, in the rectangular grid a row 60 of projectors 52 and a column 62 of projectors are identified as neutral axes which define a cross 64. For convenience and simplicity, the projection axis 46 passes through the intersection of row 60 and column 62 which is the center 66 of the cross 64. For convenience the location and address of each projector 52 may be identified by its position relative to the neutral axes 60 and 62. Thus, row 60 may be identified as R₀. The rows above row R₀ may be identified as rows R₊₁, R₊₂, R₊₃, R₊₄, . . . , R₊ₙ. The rows below row R₀ may be identified as rows R₋₁, R₋₂, R₋₃, R₋₄, . . . R₋ₙ

In a like manner column 62 may be identified as C₀. The columns to the right of column C_{c} may be identified as columns C₊₁, C₊₂, C₊₃, C₊₄, . . . , C₊ₘ. The columns to the left of column C₀ may be identified as columns C₋₁, C₋₂, C₋₃, C₋₄, . . . , C₋ₘ.

Therefore, each projector is at the intersection of a row and column with the address of the intersection of row 60 and column 62 being at R₀, C₀ and the location and address of every other projector being at R₊ₙ, C₊ₘ; where R and C identify row and column respectively, + or − indicate the side of the neutral axis on which the projector 52 is located, and n indicates which particular row while + indicates which particular column.

It will be apparent that the shape of the projection plate 48 and the number of projectors in each row 60 or column 62 is not critical. Further, there can be a different number of projectors 52 in the rows 60 as compared to the columns 62, or some rows 60 and columns 62 may have more or less projectors 52 than other rows and columns.

As seen in FIG. 2, each of the projectors 52 projects a light beam 54 through the lens system 50 and the transparent end wall 14 which creates a pattern of light dots 32A on the surface 38 of the item being scanned with each light dot 32A corresponding to the location of the projector 52 on the projection plate 48 that created it. Since the location and address of each projector 52 is known, the position of each beam 54 relative to the other beams 54 also known as will be described more fully.

The Detection System

As best seen in FIG. 2 the detection system 22 comprises at least one detection axis 68 that extends through the transparent end wall 14. It is presently preferred that there be at least two detection systems 22 and that the axis of each of them extend through transparent end wall 14. However, a device with only one detection system 22 would function in the same manner as the device described.

It will be apparent that embodiments with multiple detection systems are able to more completely scan a surface than those with fewer detection systems. None-the-less, for most purposes, and in particular the scanning of fingerprints, two detection systems 22 that are angularly disposed with respect to each other are capable of scanning a substantial portion of surface 38.

The detection axes 68 are angularly disposed with respect to each other and on opposite sides of the projection axis 46 to scan about 150 degrees. None-the-less, the principal method of the invention is the same without regard to the number of detection axes 68 being present; the sole difference being that with a larger number of detection axes 68 more of the surface 38 can be seen.

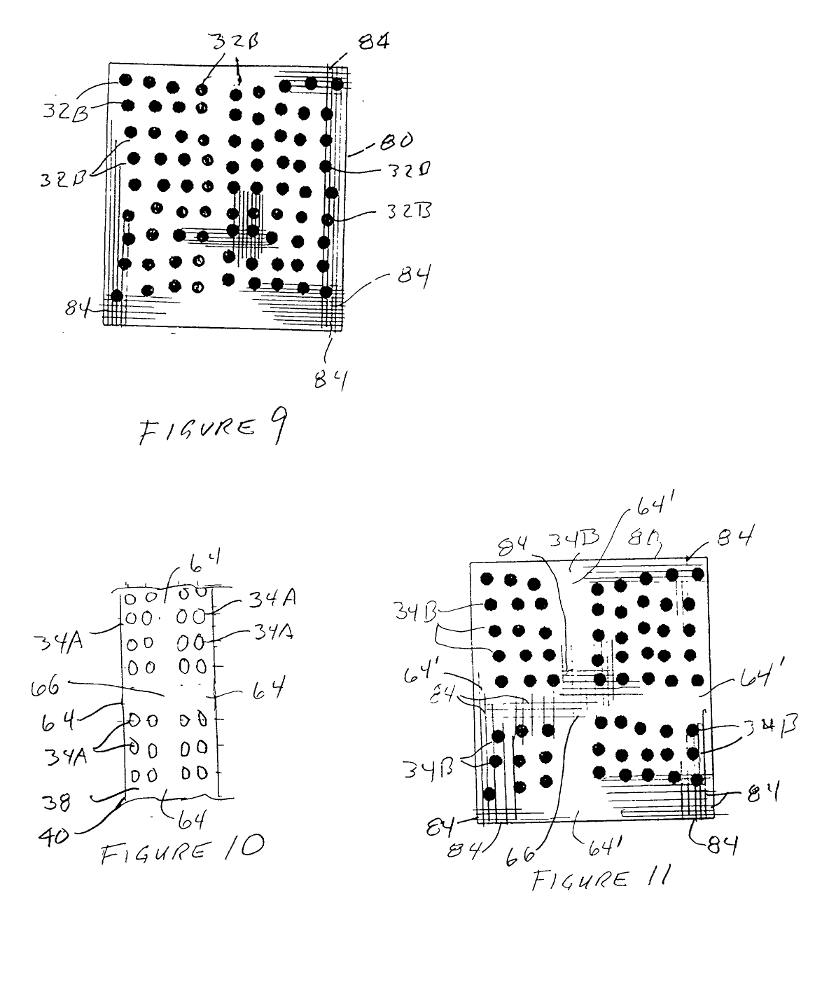

The detection system 22 also includes a CCD (charged coupled device) camera 70 disposed along each detection axis 68. The CCD camera 70 is a well known photographic device that takes a conventional picture through a conventional lens system b 76. However, as seen in FIG. 8, in its focal plane, instead of an emulsion film it has a detection plate 80 with a large number, i.e., many thousand, miniature optical detectors 84, each of which may comprise one pixel of the image. (It should be understood that the term “pixel” is taken to mean the smallest unit of an image having identical color and brightness throughout its area. Several adjacent detectors 84 that detect the identical color and brightness may also be referred to as a “pixel”). The detectors 84 are arranged in a regular grid so that the location and address of each of them is known.

Thus, starting in any convenient location, such as the upper left corner as seen in FIG. 8, the rows of detectors 84 may be identified as RR₀, RR₊₁, RR₊₂, RR₊, RR₊₄, . . . RR₊ₙ

In a like manner the columns may be identified as CC₀, CC₊₁, CC₊₂, CC_{+3,} CC₊₄. . . CC₊ₘ.

Therefore, each detector 84 is at the intersection of a row and column with the address of the intersection in the upper left corner of the plate 48 being at RR₀, CC₀, and the location and address of every other detector 84 being at RR₊ₙ,, CC₊ₘ; where RR and CC identify row and column respectively.

Instead of the light reflected from surface 38 causing a chemical change as in conventional cameras, the light falling on the CCD detectors 84 causes each of them to generate an electrical cal signal such as a voltage which is proportional to the intensity of the light that it receives. The lens system 76 of each CCD camera 70 has a focal point 88 which lies along detection axis 68. Since the location and address of each detector 84 is known, the position of each reflected beam 54′ relative to the other reflected beams 54′ is also known as will be described more fully.

As stated earlier, there are many thousands of detectors on plate 80, but only hundreds of projectors 52 on projection plate 48. The difference in number is necessary since while the source of each beam of light 54, i.e., the location of each projector 52, can be planned, the location on the detection plate 80 where the reflected beam 54′ lands can not be planned since the location where it lands is determined by the shape of the surface 38 being scanned. Therefore, a larger number of detectors is necessary to reasonably assure accuracy in determining the three dimensional coordinates of the light dots 32A. None-the-less, the number of projectors 52 and detectors 84 could be substantially reduced without departing from the invention. However, with a reduced number of projectors 52 and detectors 84 the accuracy and reliability of a device constructed in accordance with the invention would be diminished.

The Lighting System

The lighting system 24 may include conventional white or infrared lamps 94 that have a substantially instantaneous illumination and decay cycle for lighting the surface 38 in a conventional manner for the creation of the grey scale (photographic) image shown in FIG. 4 as will be more fully explained.

The programmable computer controls the timing circuit 26 which in turn controls the projection system 20, the detection system 22, and the lighting system 24l

In a presently preferred form of the invention, during a scanning cycle the timing circuit 26 energizes the projection system 20 twice, the lighting system 24 once, and the detection system 22 three times, all in a fraction of a second so that an item 40 passing through a scanning zone 100 adjacent to and overlying the transparent wall 14 will have its image scanned several times over a brief period with each scanning cycle comprising two energizations of the projection system 20 and one energization of the lighting system 24. The detection system 22 energized in parallel with the projection system 20 and lighting system 24 to capture the images that those systems create.

This substantially negates the deleterious results that occur in other surface or fingerprint scanning devices when there is relative movement between the scanning device and the item while it is being scanned.

The Method

In General

When the device 10 is used to map the surface 38 of a finger or other item 40, the object is placed in the scanning zone 100 (FIG. 1). The scanning zone 100 may have an upper limit which is defined by plate 102 that prevents the item being scanned 40 from being moved out of range of the projection and detection systems 20 and 22 and support 102B to keep the item 40 from touching the transparent end wall 14.

The surface 38 is scanned by energizing the timing circuit 26 so that the projection 20 detection 22, and lighting 24-detection 24 systems are energized in rapid succession. Preferably the item 40 is scanned about 20 times a second. The best scans are selected for use in the method.

Then, the item 40 which is to be scanned is placed in the detecting zone 100. The surface 38 is “photographed” by light emanating from the projection system 20 and lighting system 24.

For the purposes of the invention, it does not matter whether the first scan detected in a scanning cycle is of light reflected from the lamps 94 or from the projectors 52. However, for the sake of explanation, it will be assumed that the first two scans in a scanning cycle are from the projectors 52.

With this in mind, as seen in FIG. 4, the projectors 52 project a first pattern of light dots 32A onto the surface 38 which are reflected by the surface 38 onto the detection plate 80 as light clusters 34B (FIG. 9) where they are detected by the detectors 84.

Preferably there are a sufficient number of projectors 52 to place the light dots 32A at one millimeter intervals to assure an accurate reproduction of the surface being scanned. This is especially important if the surface being scanned 38 has fine detail that might be lost if the light dots were further apart.

Then, the same projectors 52 project a second pattern of light dots 34A onto the surface 38 (FIG. 10) which are reflected onto the detection plate 80 as light clusters 34B (FIG. 11). The second pattern of light dots 34A is used as a reference pattern for matching into sets the light beams 54 from particular projectors 52 and the reflected light beams 54′ that created particular light dots 32A on the surface 38. As seen in FIGS. 9 and 11, the second pattern is the same as the first pattern, except some of the projectors 52 are marked so that their reflections 34B on the detection plate 80 can be identified.

While each light cluster 32B, 34B detected by the detectors 84 is in the same location on the surface 38 relative to the other light clusters 32B, 34B as their projectors 52 were on the projection plate 48, their locations on the detection plate 80 may be displaced from their expected position due to irregularities in the surface 38 including features such as ridges, arches, bifucations, ellipses, islands, loops, end points of islands, rods, spirals, tented arches, whorls, depressions, nicks, blisters, scars, pimples, warts, hills, bumps, valleys, holes and the like. Further, the irregularities could result from the fact that the item or portions of the item whose surface is to be scanned 38 is curved, cylindrical, wavy or tapered so that not all portions of the surface are the same distance from the transparent wall 14. Therefore, the angle of a particular reflected light beam 54′ can not be predicted, nor can the location on the detection plate 80 where the light clusters 32B, 34B that it creates is detected be predicted, so the second pattern of light clusters 34B is necessary for the identification.

After each light dot 32A in the first pattern of light dots on the surface 38 is identified by a suitable method, such as triangulation, the three-dimensional coordinates that correspond to the position of that light dot 32A are identified. This is done for each particular light dot 32A by determining which projector 52 created it and which detector 84 detected it.

As is well understood, each projected beam of light 54 passes through focal point 58 and each reflected beam of light 54′ passes through focal point 88. Since the distance between the focal points 58 and 88 is easily determined when the device 10 is constructed, when the angle made by the beams of light 54 and 54′ in each set of beams from and to the projector 52 and detector 84 that created and detected them are known, sufficient information exists to locate the light dot 32A in three dimensions. The method by which this is done will be explained.

Then the lamps 94 are energized and the detectors 84 in the capture the features of the surface 38 as a grey scale (photographic) image.

Since the three-dimensional location of each of the light dots 32A in the light dot pattern is known, the location of that part of the grey scale image “seen” by the same detector that “saw” the corresponding light dot 32A is also known (FIG. 6). Therefore, those parts of the grey scale image can be mapped to the light dot pattern 32A and the remainder of the grey scale image can be added to give an accurate reproduction of the surface.

Identification Of The Light Dots In The First Pattern

However, before the accurate reproduction can be made the identity of the projector 52 and detector 84 for each particular light dot 32A must be identified. Thus, as seen in FIG. 8 the reflection of a particular light dot 32A will be detected as a light cluster 32B by many detectors 84 since there are many more detectors 84 than projectors 52, and they are much smaller and closer together than the projectors 52. However, as will be explained, each light dot 32A, 34B (32A on the surface 38; 34B on the detection plate 80) is ultimately identified by the location of the one detector 84 which is at its center.

As explained, because the images created by the projector 52 and the lamps 94 are taken at close time intervals, such as on the order of between 1/200th and 1/1000 of a second, for practical purposes it can be assumed that the item 40 is stationary. Therefore, except for the projectors 52 that are marked for identification, the light clusters 32B are in the same locations on detection plate 80 as light clusters 34B.

After the first (FIG. 4) and second (FIG. 10) light dot patterns and the grey scale image (FIG. 5) are recorded, the first and second light dot patterns are reconciled so that it can be learned which projector 52 and light beam 54 corresponds to each of the detectors 84 that detects each light beam 54′ reflected from the surface 38.

Processing Of The Light Clusters

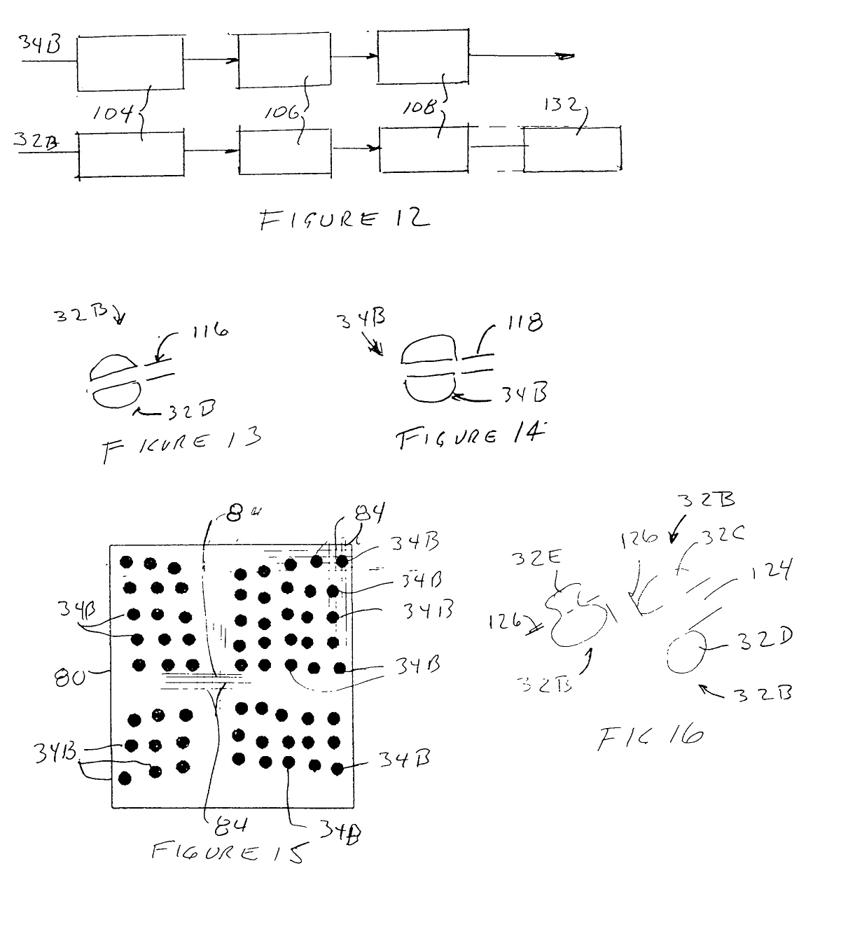

With regard to both patterns of light dots (FIGS. 4 and FIG. 10) the detectors 84 on the detection plate 80 simply detect the reflected light dots 32A, 34A in both light dot patterns (FIG. 9 and FIG. 11) as ambiguous light clusters 32B, 34B. The ambiguity arises from the fact that it is not known whether the detectors 84 on the detection plate 80 are actually detecting a reflected light dot 32A, 34A; stray ambient light or a response to a stray transient current. To remove this ambiguity, the image of the light clusters 32B, 34B are enhanced for further processing as shown in FIG. 12.

In FIG. 12 shows that the enhancement includes, for both sets of light clusters 32B and 34B, smoothing 104, increasing their intensity 106, and increasing their contrast 108.

Thus, as seen in FIGS. 13 and 14, for both detected light patterns (FIG. 9 and FIG. 11) the detected light clusters 32B, 34B are examined by a smoother 104 which detects two light clusters 32B, 32B or 34B, 34B that are separated by a gap 116, 118 having a width which is below a predetermined value. This suggests that the two light clusters 32B, 32B or 34B, 34B are actually one light cluster 32B, 34B that has been divided by a feature on the surface 30 of the item 38 such a nick, scar or any of the surface imperfections mentioned earlier. A low pass filter (not shown) may be used as the smoother 104 to restore the shape of the light cluster 32B, 34B so that the gap 116, 118 disappears. Even though the detected light cluster 32B, 34B is altered by removal of the gap 116, 118 the alteration is not significant since at this point there is no attempt to capture the image of the surface 38. All that is being done is deciding which light clusters 32B, 34B are the reflections of light dots 32A and 34A and the locations of those light clusters 32B, 34B.

Then, the intensity of the light clusters 32B, 34B is increased to make subsequent processing possible. This is accomplished by increasing the signal strength as at 106 from those detectors 84 in groups where all the detectors detect light clusters 32B, 34B. The increase in intensity may be necessary since those light clusters 32B, 34B reflected from the bottom of the finger or item 40 being mapped will be substantially brighter than those that are reflected from the side of the finger or item 40 since bottom surfaces receive the light beams 54 at a nearly vertical angle. On the other hand the side surfaces of the finger or item 40 receive and reflect the light beams at an oblique angle. It is simplest and easiest to increase the intensity of all the light clusters 32B, 34B. However, if desired, only the intensity of the less intense light clusters 32B, 34B may be increased.

As a further step, the contrast of the light clusters 32B, 34B is increased as at 108. A suitable way of achieving this is by changing the value of all of the signals from all of the detectors 84 which are not already at a binary “1” which corresponds to the detection of light, or a binary “0” which corresponds to a failure to detect light to either a “0” or a “1” depending on whether the voltage that detector generates is above or below a predetermined level. Thus, if the detected voltage is above the predetermined level, it is likely that the detector detected light and the value of that detector should be converted to a binary “1”. On the other hand, if the detected voltage is below the predetermined value, it is likely that the detector did not detect enough light to be significant and the output of that detector should be converted to a binary “0”. Other means for increasing the contrast are known and, those other means can be used in lieu of that described without departing from the spirit of the invention.

At this point the second pattern of light clusters 34B has the appearance shown in FIG. 15 and processing of the second pattern of light clusters 34B which is used for reconciliation stops as the second light cluster pattern is suitable for that purpose.

Finding the Centers of the Light Clusters in the First Pattern of Light Clusters

The first pattern of light clusters 32B detected by detection plate 80 (FIG. 9) is further processed until the center of each light cluster 32B on detection plate 80 is determined as will now be described.

Each light cluster 32B in the first light dot pattern (FIG. 8) is examined to detect its shape and its distance from adjacent light clusters 32B. This is relatively straight forward since each of the detectors 84 is at either a binary “0” or “1” so that the edge of each light cluster 32B is now clearly defined.

There are at least two possible conditions (FIG. 16) that can be detected. The first is where the light clusters 32B are spaced at a distance 124 which is above a minimum predetermined distance and the light cluster 32B is elliptical 32C or circular 32D. This condition indicate a satisfactory light cluster 32B that is ready for further processing.

In a second condition a light cluster 32B may be detected as having an hour glass shape 32E (FIG. 16). The hour glass shaped light cluster 32E is likely to be caused by two separate dots 32B and 32B overlapping each other. This might be caused when the reflected light has been diffused by the skin so that while a sharply focused light beam 54 strikes the skin, a much wider beam 54′ is reflected. When this occurs on adjacent beams 54′ their reflections will overlap. The hour glass shaped light clusters 32E are further processed by being split at their narrowest place 126 into two light clusters 32B.

The smoothing step 104, i.e., removal of gaps 116 (FIG. 13), must occur before the splitting step. This is because if these steps are reversed, a light cluster 32B such as that comprised of the two light cluster parts shown in FIG. 13 would be split into two light clusters 32B and 32B rather than being united into one light cluster 32B as is desired. Further, upon detecting two light clusters close to each other after just having been split, the smoother would try to reassemble them using the low pass filter.

Having repaired the unusable light clusters 32B in the first light dot pattern by smoothing and separating, they are now ready for further processing with the light clusters 34B of the second light pattern to determine which of them are actual reflections of light dots 32A and to ultimately identify the location of their centers.

As a part of the process of identifying the center of each light cluster 32A, its size is gradually reduced. This is accomplished by scanning each light cluster 32B several times. On each scan the detectors 84 that are on the edge of the light cluster are removed.

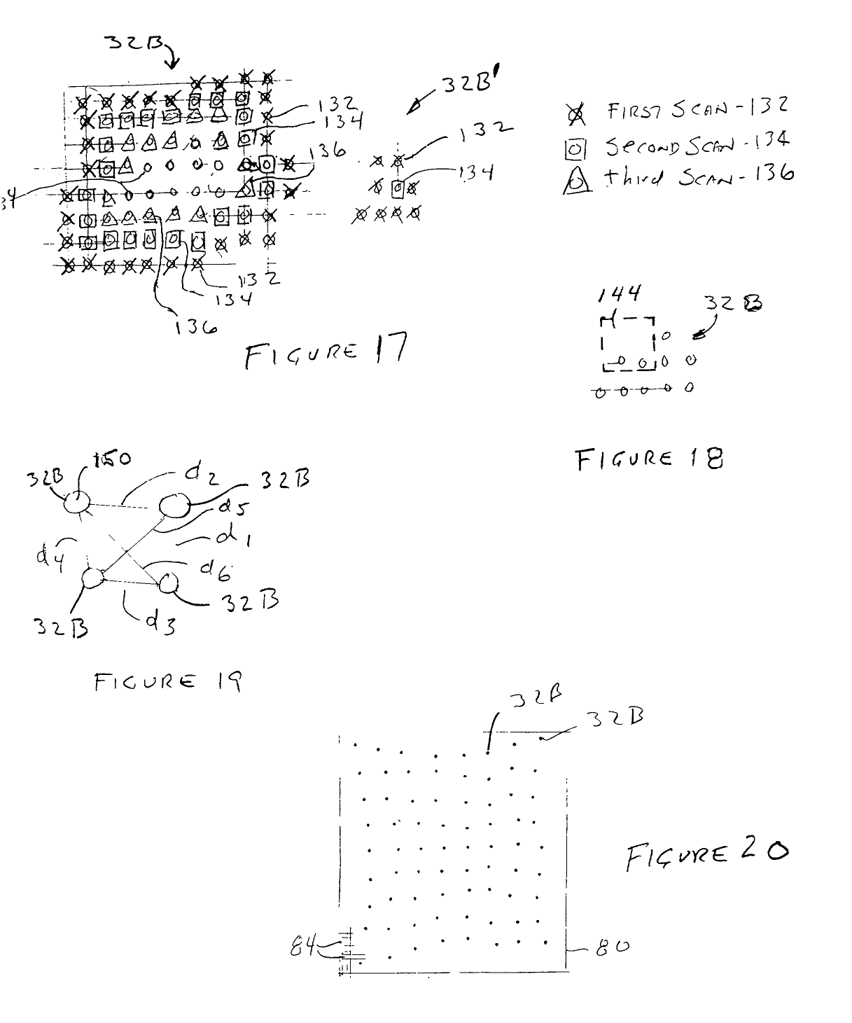

Thus, in FIG. 17 two light cluster 32B and 32B′ are seen. Light cluster 32B comprises many detectors 84. Light cluster 32B′ comprises only a few detectors 84. After, for example, three scans, 132, 134 and 136, light cluster 32B′ will disappear and can be considered as not having been the reflection of a light dot 32A.

On the other hand as seen with respect to the larger light cluster 32B, some of the detectors 84 will survive the scans. At this point the surviving light cluster 32B can be considered to be the reflection of a light dots 32A. However, each surviving light cluster 32B is comprised of a number of detectors 84.

The center of each surviving light cluster 32B is now located. The center is considered to be the location of the light cluster 32B.

If a surviving light cluster 32B comprises only one detector 84, the location of that detector is the location of the center of the light cluster.

Where a surviving light cluster 32B contains more than one detector 84 (FIG. 17), its center may be located by examining the light cluster 32B row by row and column by column to determine the row and column having the largest number of detectors 84, i.e., “1's”, which row and column define the location of the center of that light cluster 32B and hence its location.

In the alternative as seen in FIG. 18, the center of each surviving light cluster 32B can be located by finding the brightest spot in it. This may be accomplished by determining the average area of a surviving light cluster 32B and then defining an area 144 which is smaller than that average area. The area 144 is moved incrementally through each surviving light cluster 32B and the average brightness of the area 144 is determined at each location across the entire light cluster 32B, and ultimately across each surviving light cluster 32B in the first pattern of light dots (FIG. 9). The locations that provide the brightest areas, i.e., the areas having the highest values are the centers of the respective surviving light clusters 32B.

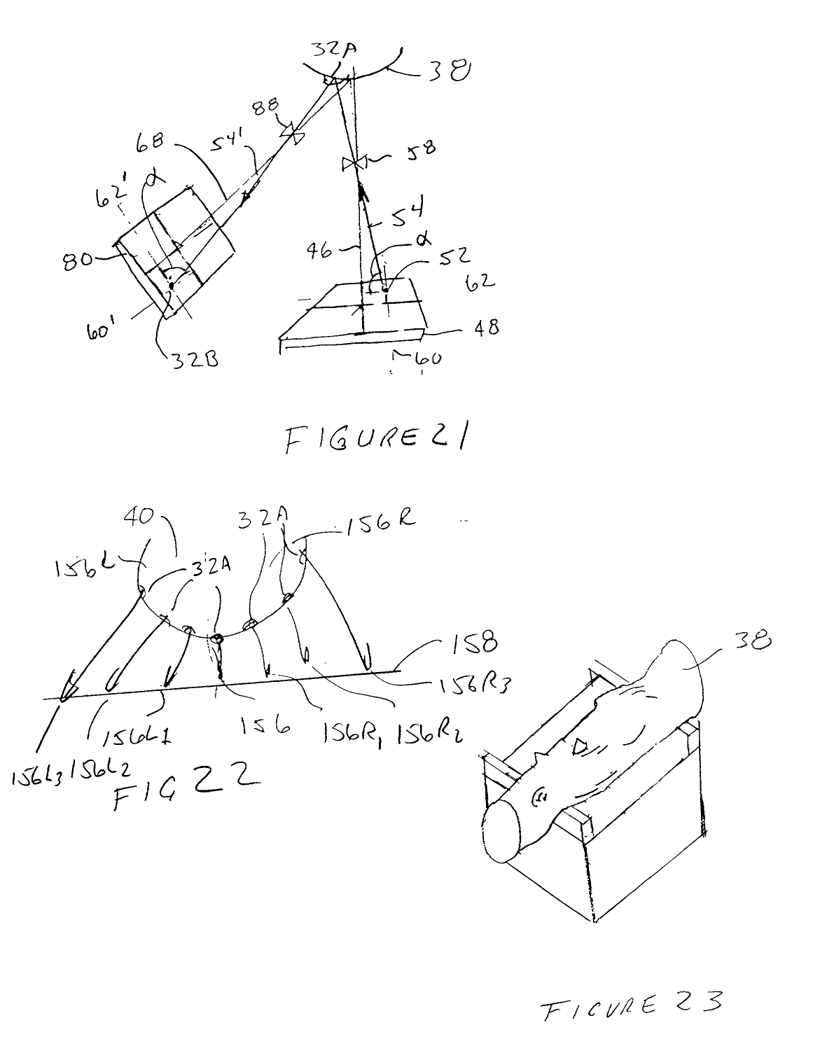

Still a third method of locating the centers of the surviving light clusters 32B is shown in FIG. 19. This method comprises the steps of determining the brightest spot 150 in a surviving light cluster 32B which spot 150 is the center of the light cluster 32B, and finding the average distance d₁, d₂, d₃, d₄, d₅, d_{etc.} between adjacent surviving light clusters 32B for all surviving light clusters detected by the entire detection plate 80.

Then, starting from brightest spot 150 detected by detection plate 80, all spots of whose brightness is above a predetermined value that are further away from spot 150 than one half of the average distance between surviving light clusters 32B, is assumed to be the center of those light clusters 32B. Thus, in this approach, spots of brightness below the predetermined value or that are closer to another spot by a distance that is than less than one half the average distance between bright spots are assumed not to be centers of the surviving light clusters 32B.

The locating of the centers of the surviving light clusters 32B on the detection plate 80 completes the processing of light clusters comprising the first light dot pattern (FIG. 4 and FIG. 9).

In FIG. 20 the centers of the light clusters 32B on the detection plate 80 are shown. Their irregular arrangement is caused by the shape of the surface 38 from which they were reflected. The coordinates of the location of each light cluster 32B is based on the address of the detector 84 on detection plate 80 which corresponds to the center of that light cluster, e.g., RR_{±n} and CC_{±m}.

After the center of each surviving light cluster 32B is located, the first light dot pattern (FIG. 4 and FIG. 9) is ready to be reconciled with the light clusters 34B in the second light dot pattern (FIG. 10 and FIG. 11) so that the light beams 54 and their projectors 52 can be matched with the particular light dot clusters 32B that they created.

It can not be predicted to where on the detection plate 80 the light beam 54 projected by a particular projector 52 will create a light cluster 32B due to irregularities in the surface 38. Therefore, reconciliation of the first and second light dot patterns is necessary so that it can be learned which projector 52 and light beam 54 created each particular reflected light beam 54′ and center of a light cluster 32B.

The Reconciliation

The reconciliation is best understood by referring to FIGS. 7 and 9 and FIGS. 11 and 15.

The first pattern of light dots 32A is accomplished by energizing all of the projectors 52 on projection plate 48 (FIGS. 4 and 7). The light dots 32A projected by those projectors 52 are reflected from the surface 38 and detected as the centers of light clusters 32B by the detectors 84 on detection plate 48 (FIG. 9) in some pattern based on the features of surface 38.

The second pattern of light dots 34A (FIG. 10) is accomplished by energizing all of the projectors 52 on projection plate 48 except those in one row 60 and one column 62 (FIGS. 10 and 11) that define the cross. The light dots 34A projected by those projectors 52 are reflected from the surface 38 and detected as light clusters 34B by the detectors 84 on detection plate 48 (FIG. 11) in the same pattern as the centers of the light clusters 32B except for the reflection of the cross 64′ (FIG. 11). However, it is not possible to predict where on the detection plate 80 the second pattern of light clusters 34B will fall since that is determined by the features of the surface 38.

As seen in FIG. 11, the detectors 84 will detect the reflection of the cross 64′ since the detectors 84 lying in its path will not detect light clusters. However, in all other respects, each other light cluster 34B created by projectors 52 in the second pattern of light dots will be in the same location as the center of the light cluster 32B created by same projector 52 in the first pattern of light dots.

The cross 64 and its reflection 64′ are useful as a frame of reference since they are easily found on the detection plate 80 because of its distinctive shape. Further, its center 66, 66′ is easily found since it is at the only location in the pattern of light clusters 32B and 34B that is surrounded by only four light clusters instead of eight light clusters. However, any other geometric shape that provides an easily identifiable reference point can be used.

The projector 52′ (FIG. 7) at the intersection of the row and column corresponding to the center 66 of the cross 64 is used as the starting place in reconciling the first and second light dot patterns. Preferably, the intersection of the row and column is on the center of the projection plate 48 such as on the projection axis 46, but the location is not critical. The projector 52′ at the center 66 of the cross 64 on the projection plate 48 is easily recognized since it will be the only projector 52 with only four of the eight adjacent projectors 52 energized. This is because the two adjacent projectors on row 60 and the two adjacent projectors on column 62 are not energized since they are on the arms of the cross. The arms of the cross will be the row 60 and column 62 of unenergized projectors 52 which extend from them.

On the detection plate 80 (FIG. 15), the cross 64 is detected by the arrangement of light clusters 34B. Thus, the first thing that is identified is the center 66′ of the reflected cross 64′. The center 66′ is recognized as being a space where there had been a light cluster 32B, but there is no light cluster 34B in that location in the second light pattern, and the space is surrounded by only four other light clusters 34B. The location of the detectors 84′ at the center 66′ of the cross 64′ is known since the coordinate address of all the detectors 84 is known.

Therefore, the coordinate address of the projector 52′ corresponds to the coordinate address of the detectors 84′. Then starting from the just found relationship between projector 52′ and detector 84′, the row and column that intersect to form the center 66′ of the cross 64′ are then related to their corresponding row and column of projectors that intersect to form the center 66 of the cross 64.

Since both patterns of light clusters 32B and 34B are virtually identical, the only difference being the presence of the cross 64 in the second light pattern, all of the centers of light clusters 32B in the first pattern of light clusters 32B must fall within the corresponding light clusters 34B in the second pattern of light clusters unless they are on the cross 64′. Thus, by referring to the coordinates for each of the centers of light clusters 32B in the first pattern of light dots which were found earlier, and determining which of those coordinates fall into light clusters 34B in the second pattern of light dots or which of those coordinates do not fall into light clusters 34B, the arms of the cross 64 can be found.

This latter possibility arises from the fact that since the projectors that created the cross were not energized they could not have produced light clusters 34B (FIGS. 11 and 15).

Thus, it is not necessary to find again the centers of the light clusters 34B in the second pattern of light dots since if the center of a light cluster 32B falls within a light cluster 34B it is not on the cross 64 and that is the only information needed.

The centers of the light clusters 32B of the first pattern of light clusters are then mapped to the second pattern of light clusters 34B to determine which projectors 52 created each of the centers of light clusters 32B.

This is accomplished by using the row 60 and column 62 defining the cross 64, 64′ as reference axes, both on projection plate 48 and on detection plate 80. In a manner similar to the conventional x-y axes of mathematical graphs, the center of each light cluster 32B and the projector 52 that created it can be paired on a row by row and column by column basis. There are as many pairs as there are light dots 32A.

After the detectors 84 that correspond to the row 60 and column 62 on the projection plate, namely, those that comprise row 60′ and column 62′ which are the arms of the reflected cross 64′ are identified, the rest of the projectors and centers of light clusters 32B are paired.

Thus, for example, a center of a light cluster 32B detected in the upper left hand quadrant defined by cross 64′ which is closest to row 60 and column 62 is known to have been projected by the projector 52 on projection plate 48 which was in the upper left hand quadrant on plate 48 which was closest to row 60 and column 62.

The center of the light cluster 32B immediately above the center of light cluster 32B just identified was necessarily created by the projector 52 immediately above the projector 52 which was just identified.

Then, moving along the row that is adjacent row 60 the coordinate address for projector 52 that created each detected center of a light cluster 32B is noted. This process is repeated for each center of a light cluster 32B until the address of each projector 52 on the projection plate 48 that created it is known.

The coordinates of the detectors that are the centers of the light clusters 32B and their respective projectors with which have been paired can be restated using coordinates that define their positions relative to the row R₀ and column C₀ on the projection plate 48 and the row RR₀ and column CC₀ on the detection plate 80 relate to the cross 64, 64′.

Thus the center 66 of the cross 64 on the projection plate 48 is identified as at row R₀ and column C₀. In a similar manner, the center 66′ of the cross 64′ on the detection plate 80 is identified as at row RR₀ and column CC₀.

Thus, the rows R_{±n} and column C_{±m} represent the rows and columns on the projection plate that are on either side of the neutral axes defined by row R₀ and column C₀. Similarly the rows RR_{±n} and column CC_{±m} represent the rows and columns on the detection plate 80 that are spaced from the neutral axes defined by row RR₀ and column CC₀.

At the completion of this process, for each light dot 32A there is known the coordinates of the projector 52 that created it and the coordinates of the detectors 84 that detected it.

The coordinates of each pair of projectors 52 and detectors 84 are used to determine the three dimensional position of each of the light dots 32A and consequently the position of that part of the surface 38 from which it was reflected.

Determining The Three Dimensional Coordinates of Each of the Light Dots

As seen in FIG. 21 the three dimensional coordinates of each light dot 32A are determined by solving two triangles, one in a plane parallel to the rows 60 and 60′ and one in a plane parallel to the columns 62 and 62′. The triangles are solved by knowing the angle(s) a at which the light beams 54 and 54′ were projected and detected and the distance between the focal points 58 and 88 of the projector and detector systems, 20 and 22, respectively.

Referring to FIGS. 3 and 21 the angle(s) a at which each beam 54 was projected is determined by the distance of its projector 52 on the projection plate 48 from the projection axis 46 in both the x direction which may be parallel to the rows 60 and the in the y direction which may be parallel to the columns 62, or they can be located by polar coordinates or any other convenient and well known system.

As explained earlier the location of x and y axes is preferably selected so that their intersection passes through the axis 46 of the projection system 20.

Therefore, the angle of the projected light beam 54 is the arctan of the distance between the projection plate 48 and the focal point 58 of the projection system 20 on the one hand and the distance from the axis 46 of the projection system 20 to the particular projector 52 that created the light dot 32A whose location is being determined as follows for each of the x and y axes:

$$∠α = arctan \frac{\begin{matrix}\begin{matrix}the distance between plate 48 and \\ the focal point 46 of the\end{matrix} \\ projection system 26\end{matrix}}{\begin{matrix}\begin{matrix}\begin{matrix}\begin{matrix}the distance between axis 46 of the \\ projection system 20 to the\end{matrix} \\ particular projector 52 that\end{matrix} \\ created the light dot 34 A whose\end{matrix} \\ location is being determined\end{matrix}} \qquad ( 1 )$$

The method for determining the angle(s) at which the light beam 54′ is reflected onto the detection plate 80 is similar to that just described.

Thus, the location of x and y axes are selected so that their intersection passes through the axis 68 of the detection system 20. Then with the distance between the detection plate 80 and the focal point 88 of the detection system 22 along axis 68 known on the one hand, and the distance from the center of each light dot 32B along the x and y axes known, the two angles, one for the x plane and one for the y plane can be solved as above to identify the angle at which each reflected light beam 54′ is received.

Since the distance between the focal point of the projector lens system 58 and the focal point 88 of the detection system is known there is sufficient information (two angles and a side) to find the height and location of the light dot 32A on the item being scanned 40 thereby establishing the location of the light dot in three dimensions.

While the position of the light dot 32A relative to the device 10 is known or can be easily calculated it is not relevant since the only meaningful information about the location of the light dot 32A is its position relative to the other light dots 32A as it is their relative positions that define the surface 38, and not their distance from the device 10.

This process is repeated until the location of each light dot 32A is known. The coordinates of each of the light dots 32A now form a three dimensional model of the surface 38.

Determining The Coordinates of The Two Dimensional Model

From the three dimensional model a two dimensional model corresponding to an item 40 such as a finger rolled along a flat medium such as a fingerprint card is created, i.e., in addition to the bottom of the item 40 being modeled, its sides are also modeled. The creation of the two dimensional is achieved by identifying those coordinates in a flat plane that correspond to the coordinates of the light dots 32A in the three dimensional model. In the two dimensional model compensation must be made for the fact that the conversion from three dimensions to two dimensions will cause a distortion in the apparent location of adjacent light dots 32A. This type of distortion is well recognized by cartographers (map makers) and others who are confronted with providing two dimensional models of three dimensional objects. A well known example of this type of distortion in cartography is the Mercator Projection which a distortion in the polar regions.

The conversion to a two dimensional model is accomplished by using a suitable set of parameters that place the coordinates that correspond to the locations of the light dots 32A in the three dimensional model in the correct positions in the two dimensional model with either invarience of angles or invarience of area, i.e., without altering either the angular relationships or areas defined by the light dots 32A.

As seen in FIG. 22, the creation of the two dimensional model is initiated by identifying those light dots 32A that lie on an axis 156 of the surface 38 that corresponds to the line of contact that would be present if the actual item 40 or finger were placed on a substrate 158 prior to rolling.

After the coordinates of those light dots 32A are established the coordinates of the light dots 32A in the next adjacent row parallel to axis 156 are identified.

The coordinates in the two dimensional plane are determined by selecting them such that the sum of a function of the differences between the distances between the light dots in the row being constructed and the light dots 32A in the previous row in the two dimensional model on the one hand, and the distances between their counterpart light dots 32A in the previous row in the three dimensional model is a minimum value.

Typically, the distances used are those to the next immediate light dots 32A to one side of the axis 156 and those immediately above and below the light dot 32A under consideration which technique is especially useful for simulating the rolling process as when capturing a fingerprint.

Other light dots 32A dots, such as those further away or on the oblique could be used in the conversion, but the two dimensional model created in this latter manner is likely to be less accurate than a two dimensional model created in the preferred manner. None-the-less, if both adjacent dots 32A and further light dots 32A are used simultaneously, the accuracy of the dot position will be increased.

First the light dots 32A on one side 156R of the axis 156 are located in the two dimensional model. This process of creating the two dimensional model is continued row by row with each row 156L₁, 156L₂, 156L₃, 156L_{etc}., corresponding to a line of rolling contact until all of the light dot 32A coordinates in the three dimensional model on that side 156R of the item 40 have been converted to the two dimensional model.

The process is repeated for the light dots 32A on the other side 156L of the item 40 starting at the axis 156 and then progressing to rows 156R₁, 156R₂, 156R₃, 156_{etc}, since the conversion to coordinates in the two dimensional plane is a simulation the rolling process.

The location of each light dot 32A in the two dimensional model is identified by a vector relating it to the detector 84 at the center of the light dot 32A in the three dimensional coordinate system on which it is based.

The coordinate addresses of the detectors 84 that were not identified as the centers of light dots 32A are mapped by interpolation using the coordinate addresses of the light dots 32A that were determined to be the light dots 32A.

The coordinates of the two dimensional model just created can be printed or displayed if desired. However, it is probably not worth while since its preferred utility occurs when it is combined with the grey scale image (FIG. 6). Accordingly, it is preferred that the two dimensional model be maintained as a data base of x-y coordinates, each of which corresponds to the position of a light dot 32A in a two dimensional plane.

A grey scale image (FIG. 6) corresponding to a rolled fingerprint or other item can now be established with accuracy since the two dimensional location of all the light dots 32A is known relative to their three dimensional coordinates.

Combining the Coordinates of the Grey Scale Image With the Coordinates of the two Dimensional Model to Create an Accurate two Dimensional Image Having a “Rolled” Appearance

The grey scale image (FIG. 6) is combined with the two dimensional coordinate data base (FIG. 22 using the coordinates of the features of the grey scale image and the coordinates of the two dimensional model. Since the grey scale image (FIG. 6) is actually physically larger than the image corresponding to the two dimensional coordinates, the larger grey scale image is combined into the two dimensional model since if it went the other way, there would be large spaces where the data from the two dimensional image did not fill the grey scale image.

Since the grey scale image was recorded on the detection plate 80 detectors, each of those detectors 84 has a grey scale value that corresponds to the amount of light that it received. Also the coordinates of each detector 84 are known. Accordingly, for each light dot 32A “seen” by a particular detector 84, there is a corresponding part of the grey scale image “seen” by that same detector 84.

Since the shift in coordinates for the light dots 32A for the two dimensional image is known, the same shift is applied to the part of the grey scale image seen by that detector 84 to create a set of two dimensional coordinates for each part of the grey scale image that accurately places that part of the grey scale image in a location that corresponds to its true position relative to the other parts of the grey scale image.

Initially, the parts of the grey scale image that have the same coordinates as their respective corresponding light dots 32A are mapped into the two dimensional model. Then the parts of the grey scale image that are not on the light dots 32A are located to their true positions relative to the two dimensional model by interpolation using the shifts in position of the light dots 32A nearest to them.

If there is only one detection system that includes a CCD camera 70 in the device, sufficient information now exists, i.e., the coordinates of each part of the grey scale image to print it, display it or store it or use it for analysis or comparison with other items.

In a device with only one detection system 22, only that part of the surface 38 that is facing the detection system can be “seen.”

A Composite Image Made From a Device Having two Detector Systems

However, in the preferred embodiment of the invention which is illustrated in FIG. 2, there are two detection systems 22, each of which includes a CCD camera 70 and detection plate 80. The two detection systems 22 are angularly disposed with respect to each other so that a larger portion of the surface 38 of the item 40 can be seen than if only one detection system 22 were used. Thus, with the arrangement seen in FIG. 2 the two CCD cameras 70 can scan the sides of an item 40 through an included angle of up to 150 degrees. By increasing the angle between detection systems 22, the included angle can exceed 180 Degrees.

Further, by the inclusion of a third or fourth detection system 22, more precise mapping through the increased angle of scanning can be achieved that with the two detection systems 22 described.

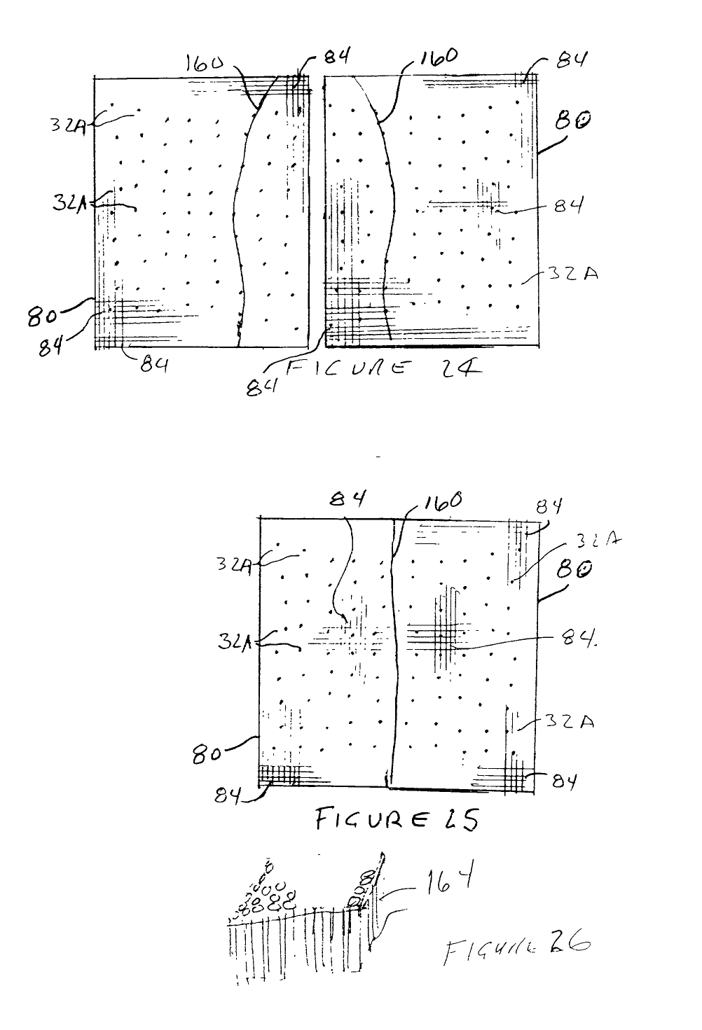

As seen in FIG. 23, an elongated device 10 having plurality of projection systems 20 and detection systems 22 similar to those described are located along the longitudinal axis of the item to be scanned 40. Such an arrangement is able to examine large objects such as a limb or the entire body of a person or animal. Further, a device of sufficient size operating according to the principles of the invention just described could scan a manufactured item or an art object having a surface texture. Such scans would be useful for identification or the detection of forgeries or alterations.

Further, it should be noted that if the item is rotated in increments, its entire circumferential surface can be mapped.

In those devices 10 having two or more detection systems 22, each detection system 22 processes the light dots 32A and grey scale image that it “sees” in a manner that is identical to that which has been described. However, the portion of the light dot patterns 32A and 34A and the portions of the grey scale image seen by each of them are for a different part of the item 40 than was seen by the other detection system 22.

Therefore, to have a composite grey scale image that corresponds to a finger or other item 40 which is rolled through about 180 degrees, the grey scale images created by each detection system 22, whether in a configuration such as shown in FIG. 2 or that shown in FIG. 23 must be combined and any part of the surface 38 that was scanned by more than one detection system 22 must identified so that they can be overlapped, removed, or compensated for in some other fashion.

A composite image made from the multiple detection system of the device 10 shown in FIG. 2, will be described. As seen in FIG. 24, since a cross 64 was used while capturing both the first and second light dot patterns, it will appear in the light dot patterns 32B seen by each detector system 22. Since the detector systems 22 are circumferentially spaced around the item 40, the cross 64 will be reflected onto to each detection plate 80 in a different location from the other detection plate 80.

Then, by the method described, the coordinates for each light dot 32A is determined. Using the cross as a frame of reference, the coordinate system of light dots 32A on both detection plates 80 can be combined into one coordinate system.

Then, the light dots 32A on one of the detection plates 80 having coordinates identical to the coordinates of a light dot 32A on the other detection plate 80, and their corresponding grey scale images can be discarded since they are merely the same light dots 32A and grey scale images that are seen by more than one detection system.

In the alternative, light dots 32A which appear in the images seen by both detector systems 22 and their corresponding grey scale images can be identified and the extent of overlapping be determined. A suitable line such as a line of light dots 160 (FIGS. 24 and 25) that appear on both detection plates 80 is identified (FIG. 24).

Then the two images can be merged by assembling the part of the scanned images that is on the outside of the line of light dots 160 which appear on both images. This is because the portions of the image between the line of light dots 160 on each of the images is on the outside of the line of light dots on the other image and hence, becomes a part of the composite image.

Since the grey scale value for the coordinates for each part of the composite image is known, the grey scale value for the coordinates for each part of the composite grey scale image is known.

The result is a data base of coordinates that define a composite grey scale image that corresponds what the image of a rolled fingerprint or other item would look like. The data base can be stored for later use or can be displayed on a monitor or printed on a fingerprint card or other suitable medium for storage or comparison.

Alternative Devices for Creating the First and Second Light Dot Patterns

There are several devices and systems for creating the First and second patterns of light dots 32A and 34A.

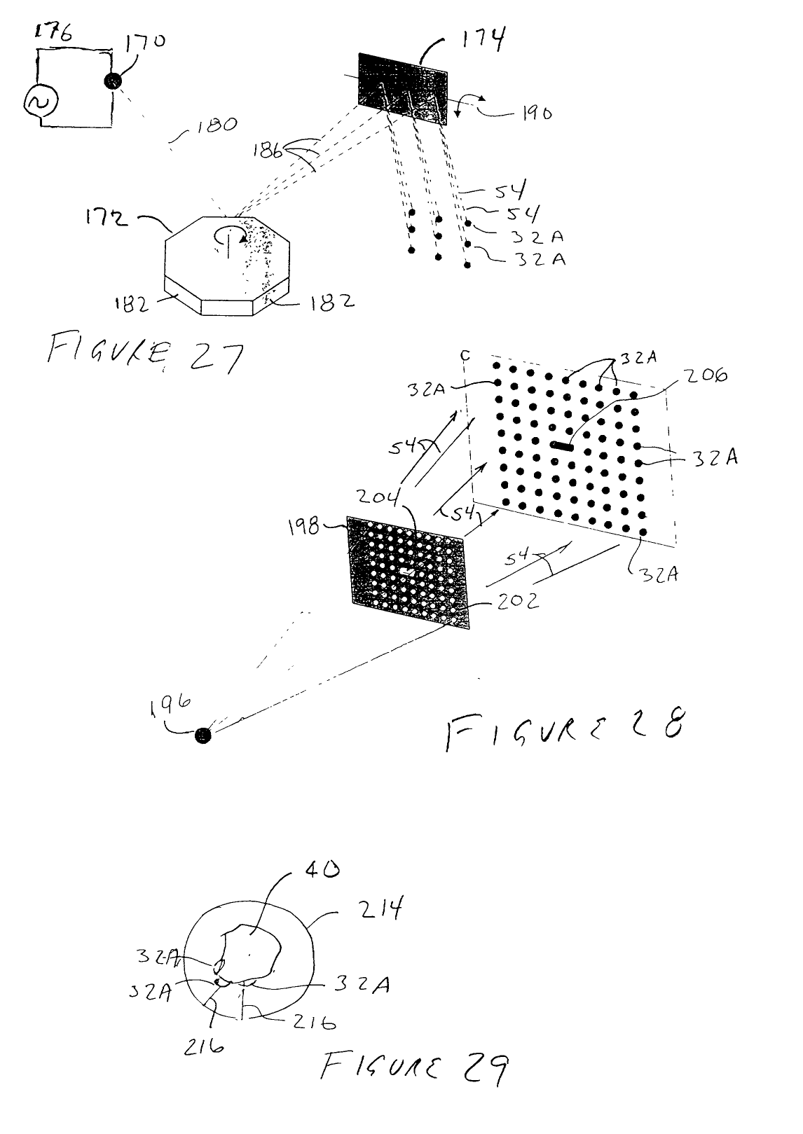

Thus, as seen in FIG. 26 instead of using the projectors 52 on projection 48 to create the light beams 54, they could be created by fiber optic rods 164 that are bundled into an appropriate configuration.

Further, in FIG. 27 a narrow beam light source 170, a rotating mirror 172 and a pivoting mirror 174 create the light beams 54 and light dots 32A and 34A. The narrow beam can be created by a laser, or by an optical system. A suitable circuit 176 is provided for energizing the light source 170 at high frequencies. The beam of light 180 that it generates is aimed at the perimeter of the rotating mirror 172. The perimeter of the rotating mirror 172 has a plurality of reflective surfaces 182. By coordinating the energization of the light source 170 and the rotational speed of the rotating mirror 172 a row having a desired number of directed light beams 186 at suitable spacing can be created.

In the device being described, the light beams 186 are aimed at the pivoting mirror 174 where they are reflected as a row of light beams 54 which create a row of light dots 32A on the surface 38 of the item 40 being scanned. By pivoting the mirror incrementally about axis 190 and with an appropriate lens system (not shown) a plurality of rows of light dots 32A will be created on the surface 38 of the item 40 being scanned. The light dots 32A are detected by the detection plates 80 as light clusters 32B as have been described.

By further integrating the energization of the light source with the movements of the rotating mirror 172 and the pivoting mirror 174 a second pattern of light dots 34A having a cross 64 or other marking device such by simply being larger than the other light dots 32A can be projected on to the surface 38. Then, as described, by relying on the distance between the focal points of the projection and detection systems and the angles of the pairs of projected light beams 54 and reflected light beams 54′ relative to their respective projection and detection axes, the three dimensional coordinates of each of the light dots 32A can be found.

A still further system for creating the light dot pattern 32 on the surface to be scanned 38 is shown in FIG. 28. It includes a wide beam light source 196 and a mask 198 having a pattern of holes 202 that correspond to the desired pattern of light dots 32A is provided. At least one of the holes 204 in the mask 198 has a distinctive shape. The mask breaks the wide beam into a plurality of separate light beams 54. Each of the light beams 54 creates one of the light dots 32A. The light dot 206 created by the hole 204 in the mask 198 has a distinctive shape so that it can be used to help match the projected light beams 54 and reflected light beams 54′ into pairs as was explained.

An yet even further system for creating the pattern of light dots 32A comprises a plurality of projection systems. The systems may be identical or different. They may generate the same number of light dots 32A or a different number of light dots, provided, the light dots 32A cover the surface 38 of the item being scanned 40 in sufficient number so as to enable the creation of an accurate three dimensional model of the surface 38.

It should be understood that when using a distinctive light dot for the reconciliation, the dot must be found before the step of smoothing 104 since the smoothing might destroy the distinctive light dot rendering identification of the light dots impossible. Preferably an algorithm designed to specifically detect the distinctive light dot is used.

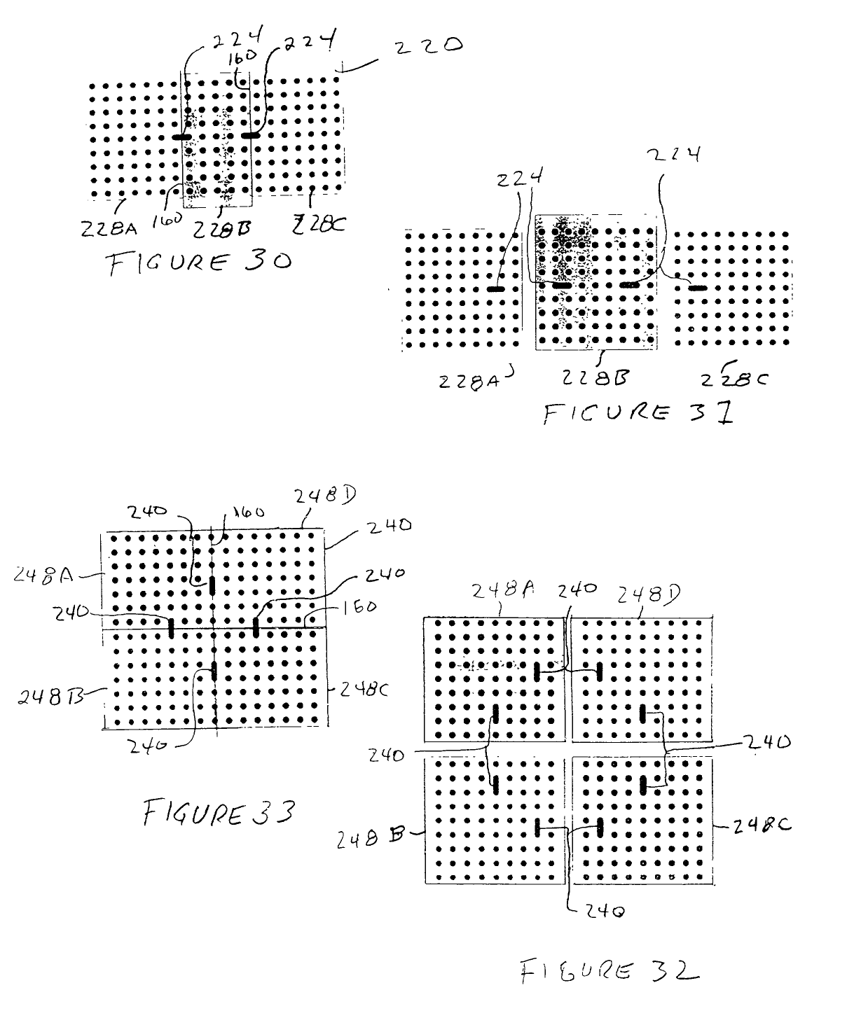

In FIGS. 30 and 31 a composite scanned image 220 based on three detection systems 22 and a distinctive light dot 224 is shown. The distinctive light dot 224 is seen in the light dot patterns 228A, 228B and 228C in FIG. 30; each of which was scanned by a different detector system 22. In FIG. 31 the light dot patterns 228A, 228B and 228C are shown assembled along cut lines 160 into a composite image in a manner similar to that described with respect to the composite image shown in FIG. 25. Further, it should be noted that the distinctive dot 224, seen in each of the light dot patterns 228A, 228B and 228C is used for aligning the images when creating the composite image 220.

In FIGS. 32 and 33 a composite scanned image 240 based on four detection systems 22 and a distinctive light dot 244 is shown. The distinctive light dot 244 is seen in the light dot patterns 248A, 248B, 248C and 248D in FIG. 32; each of which was scanned by a different detector system 22. In FIG. 33 the light dot patterns 248A, 248B, 248C and 248D are shown assembled into a composite image along cut lines 160 in a manner similar to that described with respect to the composite image shown in FIG. 25. Further, it should be noted that the distinctive dot 240, seen in each of the light dot patterns 248A, 248B and 248C is used for aligning the images when creating the composite image 240.

Alternative Methods for Three Dimensional Mapping

When the item to be scanned is generally cylindrical such as a finger or limb, an alternative to the method for finding the coordinated of the three dimensional model comprises the step of creating a model of a perfect cylinder 214 such as seen in FIG. 29 which is assumed to be the item being scanned 40. The diameter of the perfect cylinder is based on the average item width seen by the detection system 22.

If the item being scanned 40 were a perfect cylinder, the location of each light dot 32A on it can be anticipated. Then if the actual light dot 32A is not where the anticipated dot is expected to be, that part of the finger may be fatter or thinner than the ideal cylinder. Thus, if the actual light dot 32A falls above the anticipated light dot 32A that part of the finger is fatter than the perfect cylinder. If it falls below then the finger is thinner.

The position of each light dot on the perfect cylinder can be anticipated then all that needs be done is to note the difference 216 between the actual location of the dot and the place that it would be on a perfect cylinder.

It can be appreciated from the foregoing description of the preferred embodiment sds of the invention that in addition to scanning generally cylindrical items, the device and method of the invention can also be used to scan the surfaces of other three dimensional objects such as rectangular solids, cubes, pyramids, polyhedrons, spheres, cones, elliptical solids and combinations of these shapes. Further, the invention can be used to map the surfaces of relatively flat body parts such as palms, footprints and “slap prints”, i.e., four fingers printed at the same time. Further, manufactured items such as forgings, castings and items made by other manufacturing processes can be examined to detect imperfections or to determine if manufacturing tolerances are met.

Thus, while the invention has been described by referring to its presently preferred embodiments, it is apparent that other forms and embodiments will be obvious to those skilled in the art from the foregoing description. Thus, the scope of the invention should not be limited by the description, but rather, only by the scope of the appended claims.

1. A method of scanning and capturing the image of a fingerprint which fingerprint has a plurality of features, each feature being at a particular place on said fingerprint, said method comprising the steps of:
placing a finger whose fingerprint is to be scanned in a scanning zone,
placing a plurality of reference points on said fingerprint so that some of said reference points correspond to some of said features, and
determining the location of said features on said fingerprint by determining the location of the reference points that correspond to said features so that said image is captured.

2. The method as defined in claim 1 including:
the step of reproducing the image of said fingerprint.

3. The method as defined in claim 2 wherein:
said image is reproduced in an electronic display.

4. The method as defined in claim 2 wherein:
said image of said finger print is reproduced by being printed.

5. The method as defined in claim 4 including:
the step of providing a fingerprint card, and printing said image of said fingerprint on said fingerprint card.

6. The method as defined in claim 1 including:
the step of providing a data base, and storing the image of said fingerprint in said data base.

7. The method as defined in claim 1 including:
the step of providing a comparator,
transmitting an image of a first fingerprint to said comparator,
transmitting an image of a second fingerprint to said comparator, and
comparing said images of said fingerprints.

8. The method as defined in claim 7 including:
the step of providing a data base for storing the images of fingerprints, and
said image of said second fingerprint is transmitted from said data base to said comparator.

9. The method as defined in claim 1 including:
the step of providing a remote means for receiving images of fingerprints, and
transmitting said image of said fingerprint to said remote means.

10. The method as defined in claim 1 wherein;
said plurality of reference points are placed on said fingerprint by being projected.

11. The method as defined in claim 10 wherein:
said plurality of reference points are projected from an infrared projector.

12. The method as defined in claim 1 including the steps of:
capturing the image of said reference points, and
capturing the image of said fingerprint features.

13. The method as defined in claim 12 including;
the step of moving the finger being scanned through said scanning zone, and
the interval of time between said step of capturing the image of said reference points and said step of capturing the image of said fingerprint features is small enough to substantially stop the movement of said finger.

14. The method as defined in claim 12 including:
the step of providing means for capturing images and
said means for capturing images captures said image of said reference points and said image of said fingerprint features.

15. The method as defined in claim 14 including;
the step of moving the finger being scanned through said scanning zone, and
said means for capturing images including a plurality of pixels,
the interval of time between said step of capturing the image of said reference points and said step of capturing the image of said fingerprint features is small enough to substantially stop the movement of said finger.

16. The method as defined in claim 15 wherein:
said step of providing means for capturing images includes the step of providing a plurality of pixels for capturing said images,
the step of determining the location of said features on said fingerprint by determining the location of the reference points that correspond to said features so that said image is captured includes the steps of:
providing first and second axes that extend through said scanning zone, and
determining the angle of each of said reference points relative to each of said axes.

17. The method as defined in claim 10 including the step of:
projecting said reference points simultaneously.

18. The method as defined in claim 17 including the step of:
providing a plurality of separate light sources, and
each of said light sources projects one of said reference points.

19. The method as defined in claim 18 including the step of:
providing a plurality of fiber optic rods, and
each of said fiber optic rods projects one of said reference points.

20. The method as defined in claim 17 including the steps of:
providing a light source,
dividing the light from said light source into a plurality of separate beams, and
each of said beams projects one of said reference points.

21. The method as defined in claim 20 including the steps of:
providing a plurality of fiber optic rods, and
said fiber optic rods divide the light from said light source into a plurality of separate beams.

22. The method as defined in claim 21 including the step of:
providing a mask having a plurality of openings for the transmission of light, and
said mask divides the light from said light source into a plurality of separate beams.

23. The method as defined in claim 10 including the step of:
projecting said reference points serially.

24. The method as defined in claim 23 including the step of:
providing a light source,
selectively energizing said light source, and
displacing the beam emanating from said light source between said steps of selectively energizing said light source to create said reference points.

25. The method as defined in claim 24 wherein said step of providing a light source includes the step of:
providing a laser projector.

26. The method as defined in claim 24 wherein said step of providing a light source includes the step of:
providing an infrared light generator.

27. The method as defined in claim 24 wherein said step of displacing the beam emanating from said light source includes the step of:
redirecting said light beam.

28. The method as defined in claim 27 wherein said step of redirecting said light beam includes the steps of:
providing a reflector, and
displacing said reflector.

29. The method as defined in claim 10 including the step of:
projecting said some of said reference points simultaneously, and
projecting some of said reference points serially.

30. The method as defined in claim 29 including the step of:
providing a plurality of separate light sources, and
each of said light sources projects a plurality of said reference points.

31. The method as defined in claim 30 including the step of:
selectively energizing said light sources simultaneously, and
displacing the beams emanating from said light sources between said steps of selectively energizing said light source to create said reference points.

32. The method as defined in claim 31 wherein said step of providing light sources includes the step of:
providing a laser projectors.

31. The method as defined in claim 31 wherein said step of providing light sources includes the step of:
providing infrared light projectors.

32. The method as defined in claim 31 wherein said step of displacing the beams emanating from said light sources includes the step of:
redirecting said light beams.

33. The method as defined in claim 32 wherein said step of redirecting said light beams includes the steps of:
providing a reflector, and
displacing said reflector.

34. The method as defined in claim 24 wherein
said step of displacing said light beams includes the step of displacing said light sources.

35. (Broad idea) A method of scanning and capturing an image of a surface which surface has a plurality of features, each feature being at a particular place on said surface, said method comprising the steps of:
placing said surface which is to be scanned in a scanning zone,
placing a plurality of reference points on said surface so that some of said reference points correspond to some of said features, and
determining the location of said features on said surface by determining the location of the reference points that correspond to said features so that said image is captured.

36. The method as defined in claim 35 including:
the step of reproducing the image of said surface.

37. A device for scanning the surface of an item comprising
a scanning zone,
means for projecting a pattern of light dots onto the surface to be scanned when it is in said scanning zone,
means for detecting said pattern of light dots,
means for making a grey scale image of the surface, and
means for combining said light dot pattern with said grey scale image to create a two dimensional reproduction of the item that was scanned.
